(19) United States
(12) Patent Application Publication
(10) Pub. No.: US 2023/0117444 A1
(43) Pub. Date: Apr. 20, 2023

(54) ULTRA-LOW LATENCY STREAMING OF REAL-TIME MEDIA

(71) Applicant: Microsoft Technology Licensing, LLC, Redmond, WA (US)

(72) Inventors: Rajesh Gunnalan, Sammamish, WA (US); Mihhail Konovalov, Kirkland, WA (US); Tin Qian, Redmond, WA (US); Timothy Mark Moore, Bellevue, WA (US)

(73) Assignee: Microsoft Technology Licensing, LLC, Redmond, WA (US)

(21) Appl. No.: 17/505,326

(22) Filed: Oct. 19, 2021

(51) Int. Cl. H04L 29/06

(52) U.S. Cl. CPC H04L 65/601; H04L 65/607; H04L 65/4069; H04L 65/80; H04L 65/608

(57) ABSTRACT

Techniques are described for low-latency real-time streaming of media content. For example, streaming media content can be received from a media source, where the streaming media content comprises audio and/or video content. An audio/video stream can be streamed to one or more streaming clients. The audio/video stream is streamed as a sequence of encoded audio and/or video frames, which are independent encoded audio and/or video frames that are not grouped into chunks for streaming. The sequence of encoded audio and/or video frames is streamed to the one or more streaming clients as a one-way stream and without receiving any requests from the one or more streaming clients for subsequent frames or chunks.

### BACKGROUND

Based on the interaction and engagement need, online meetings can be broadly divided into interactive meetings (e.g., called fast lane meetings) and passive meetings (e.g., called slow lane meetings). Interactive meetings are the typical online meetings where participants can freely contribute to the media session (e.g., chatting, screen sharing, etc.). Passive meetings effectively perform content delivery to the meeting participants with no option for the participants to interact or contribute media content to the online meeting. Passive meetings typically leverage streaming technologies and traditional content delivery networks (CDNs) to deliver the streaming media.

Passive meetings can scale to handle global scale media delivery. However, passive meetings experience significant latency. For example, latencies for passive meetings (e.g., introduced by CDNs and/or buffering) can be about 30 seconds. The inherent latency associated with passive meetings precludes any kind of meaningful interaction or engagement with the presenters or other meeting participants.

Interactive meetings support interaction between the meeting participants due to their low latency, but they are difficult to scale to a large number of users, and even scaling to a moderate number of users can add significant complexity (e.g., in terms of computer and network hardware, bandwidth, etc.). For example, interactive meetings may be suited to up to about 1,000 users.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Technologies are described for low-latency real-time streaming of media content. For example, operations can be performed for receiving, from a media source, streaming media content, where the streaming media content comprises audio and/or video content. The operations can further comprise streaming an audio/video stream with a sequence of encoded audio and/or video frames, generated from the streaming media content, to one or more streaming clients, where the sequence of encoded audio and/or video frames is streamed as independent encoded audio and/or video frames without grouping frames into chunks for the streaming. The sequence of encoded audio and/or video frames is streamed to the one or more streaming clients as a one-way stream and without receiving any requests from the one or more streaming clients for subsequent frames or chunks.

As another example, technologies are described for low-latency real-time streaming of media content. For example, operations can be performed for sending, to a delivery node, a request for available audio/video streams for streaming identified streaming media content. The operations can further comprise receiving, from the delivery node, stream metadata describing a set of pre-defined available audio/video streams for streaming the streaming media content, where the set of pre-defined plurality of audio/video streams are client-independent audio/video streams that are not specific to any given streaming client. The operations can further comprise sending, to the delivery node, a selection of an audio/video stream from the set of pre-defined available audio/video streams, The operations can further comprise receiving, from the delivery node, the audio/video stream, where the audio/video stream is received as a sequence of encoded audio and/or video frames that are independent encoded audio and/or video frames without grouping frames into chunks. The sequence of encoded audio and/or video frames is received as a one-way stream and without sending any requests to the delivery node for subsequent frames or chunks.

### BRIEF DESCRIPTION OF THE DRAWINGS

FIG. 1 is a block diagram depicting example environment for low-latency real-time streaming of media content.

FIG. 2 is a diagram depicting an example environment for low-latency real-time streaming of media content, including streaming of multiple pre-defined audio/video streams.

FIG. 3 is a flowchart of an example method for low-latency real-time streaming of media content.

FIG. 4 is a flowchart of an example method for low-latency real-time streaming of media content, including sending stream metadata.

FIG. 5 is a flowchart of an example method for low-latency real-time streaming of media content, including using stream metadata to select an audio/video stream.

FIG. 6 is a diagram of an example computing system in which some described embodiments can be implemented.

FIG. 7 is an example cloud-support environment that can be used in conjunction with the technologies described herein.

### DETAILED DESCRIPTION

### Overview

The following description is directed to technologies for low-latency real-time streaming of media content. For example, streaming media content can be received from a media source, where the streaming media content comprises audio and/or video content. An audio/video stream can be streamed to one or more streaming clients. The audio/video stream is streamed as a sequence of encoded audio and/or video frames, which are independent encoded audio and/or video frames that are not grouped into chunks for streaming. Furthermore, the sequence of encoded audio and/or video frames is streamed to the one or more streaming clients as a one-way stream and without receiving any requests from the one or more streaming clients for subsequent frames or chunks.

The technologies described herein can be used to efficiently (e.g., with low overhead) stream audio/video content to streaming clients with low latency. The technologies described herein provide various advantages over existing streaming solutions (e.g., existing content delivery network (CDN) solutions), including existing streaming solutions that organize streaming content into chunks for streaming (also referred to as file-based streaming or segment-based streaming) With existing solutions that organize streaming content into chunks, the client receives a manifest send requests for a next chunk of streaming content on a periodic basis (e.g., every few seconds). In addition, such existing solutions cache (e.g., buffer) the chunks at various locations within the network (e.g., at various content delivery nodes). As a result, such existing solutions have high latency and high overhead.

According to a first example advantage and improvement, the technologies described herein directly carry video and/or audio samples with low overhead. This is in contrast to existing solutions (e.g., streaming protocols such as HLS and DASH) in which video and/or audio samples are organized into chunks (also called files or segments) which the client then requests (e.g., the client would periodically request the next chunk, such as the next 2-second chunk, of video and/or audio data).

According to a second example advantage and improvement, the technologies described herein reduce the overhead of receiving video and/or audio samples because the streaming client does not have to request audio and/or video samples from the computing device (e.g., server) sending the audio and/or video samples. In other words, during streaming the client does not send any requests to the server (i.e., the client merely receives the streamed audio and/or video frames without any requests or polling). By not sending any request or performing any polling operations during streaming, the technologies described herein provide reduced overhead (e.g., reduce computing resource utilization, such as processor, network bandwidth, and memory utilization) and reduced latency (e.g., the client does not spend time sending a request for a next chunk and waiting for the response). This is in contrast to existing solutions, such as existing content delivery network solutions, in which the client requests (e.g., as a polling operation) each next chunk of streaming media content.

According to a third example advantage and improvement, the technologies described herein implement efficient forking of audio/video streams. Forking is performed using new techniques that result in lower overhead, lower latency, and reduced computing resource utilization. For example, forking can be accomplished by sending audio and/or video frames to one or more additional streaming clients and without having to modify header information of every frame (e.g., the frames can be sent to the additional streaming clients as they are received without any modification or other processing). The forking can be performed with minimal setup (e.g., sending a manifest from which the client or delivery node selects the stream or streams to receive). Once the minimal setup is performed, the streaming can begin and continue without any additional requests from the client or delivery node. Other advantages and improvements will be discussed elsewhere herein.

### Terminology

The term “media source” refers to a source of streaming audio and/or video content. In some implementations, the streaming audio and/or video content is real-time streaming audio and/or video content. For example, the real-time streaming audio and/or video content can be from a real-time video conference or meeting (e.g., generated by compositing audio and/or video content from multiple participants into a composited audio and/or video stream). The media source can provide the streaming audio and/or video content in a variety of formats. For example, the streaming audio and/or video content can be provided as unencoded (e.g., raw) audio and/or video samples (e.g., generated by locally connected or remote audio and/or video capture devices). The streaming audio and/or video content can also be provided as encoded audio and/or video data (e.g., encoded according to corresponding audio and/or video coding standards).

The term “audio/video stream” refers to a stream containing a sequence of encoded audio and/or video frames (e.g., comprising corresponding audio and/or video samples). The encoded audio and/or video frames are encoded via a corresponding audio and/or video codec. A given audio/video stream is encoded with a specific pre-defined quality (e.g., a specific resolution, bitrate, etc.). The term pre-defined quality indicates that the quality is client-independent and not specific to any given streaming client. In other words, the streaming technology described herein can provide a number of pre-defined quality audio/video streams for the streaming client to select from.

The term “stream metadata” refers to information describing the audio/video streams that are available from a given delivery node for specific streaming media content. The information includes an indication of the pre-defined quality for each available audio/video stream (e.g., the resolution, bitrate, etc.). For example, there could be three available audio/video streams with differing pre-defined qualities for streaming identified streaming media content. The stream metadata could identify the three available audio/video streams with labels such as “high” quality, “medium” quality, and “low quality. The stream metadata could also provide more specific information describing the three available audio/video streams (e.g., indicating that a first audio/video stream has 720p video quality, that a second audio/video stream has 1080p video quality, and so on). The stream metadata could also identify the specific audio and/or video codec used for a given audio/video stream (e.g., indicating that a first audio/video stream contains AAC encoded audio data and H.264 encoded video data).

The term “delivery node” refers to software and/or hardware that is configured (e.g., via software instructions) to perform low-latency real-time streaming of audio/video streams. A delivery node could be a primary delivery node or a client delivery node. A primary delivery node typically operates in a cloud environment (e.g., implemented via cloud computing services) and distributes audio/video streams to end-user clients as well as to client delivery nodes. A client delivery node typically operates in a network of an organization and distributes audio/video streams to end-user clients as well as to other client delivery nodes (e.g., within the organization).

The term “streaming client” refers to a client that receives an audio/video stream. A streaming client can be an end-user client that is the destination for the audio/video stream. For example, an end-user client can be a software application running on a computing device (e.g., laptop or desktop computer, tablet, smart phone, or another type of computing device) that decodes and presents (e.g., via audio and/or video playback) the received audio/video stream. A streaming client can also be a client delivery node that further distributes the audio/video stream (e.g., to other end-user clients and/or to other client delivery nodes).

### Environments for Low-Latency Real-Time Streaming of Media Content

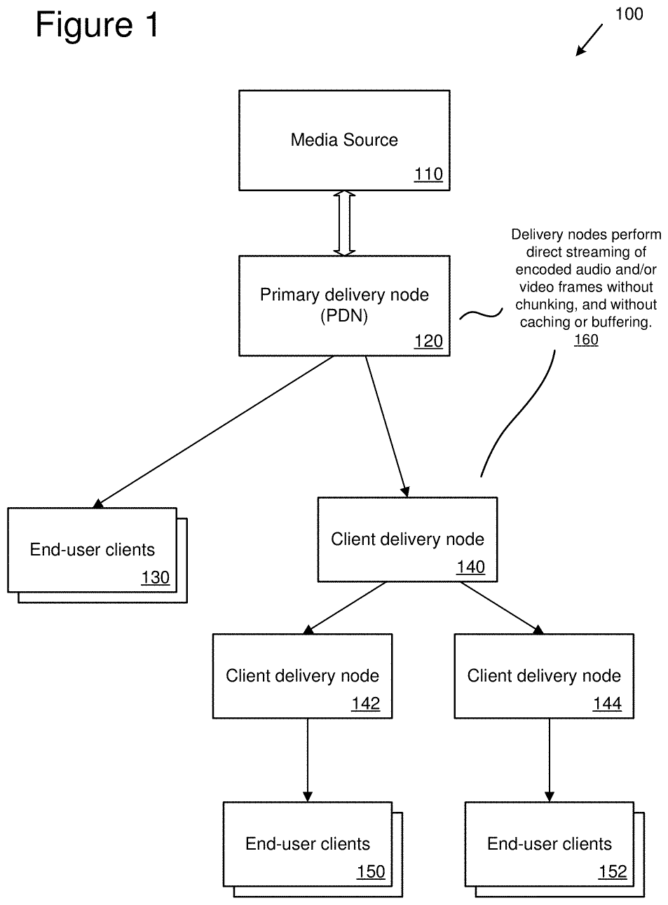

FIG. 1 is a diagram depicting example environment 100 for low-latency real-time streaming of media content. The example environment 100 includes a media source 110. The media source 110 is a source of streaming audio and/or video content (e.g., unencoded or encoded audio and/or video content).

The example environment 100 includes a primary delivery node (PDN) 120. The primary delivery node 120 receives streaming audio and/or video content from the media source 110. For example, the primary delivery node 120 can receive the streaming audio and/or video content in the form of unencoded audio and/or video samples or in the form of encoded audio and/or video frames (e.g., at one or more quality levels). In some implementations, the primary delivery node 120 receives unencoded audio and/or video content from the media source 110, and performs audio and/or video encoding operations (e.g., using audio and/or video codecs) to generate encoded audio and/or video streams at one or more quality levels. In some implementations, the primary delivery node 120 receives the streaming audio and/or video content in an already encoded format (e.g., encoded at one or more quality levels), and can perform relay and/or transcoding operations. The primary delivery node 120 provides audio/video streams to client delivery nodes, including to client delivery node 140, and to end-user clients, including to end-user clients 130.

The example environment 100 includes client delivery nodes 140, 142, and 144. For example, client delivery nodes 140, 142, and 144 could be located within a network of an organization to serve clients that are local to the organization. The client delivery nodes 140, 142, and 144 deliver audio/video streams to other client delivery nodes and/or to end-user clients. As depicted, client delivery node 140 delivers audio/video streams to client delivery nodes 142 and 144. Client delivery node 142 delivers audio/video streams to end-user clients 150. Client delivery node 144 delivers audio-video streams to end-user clients 152.

Audio/video streaming is performed within the example environment 100 (by the primary delivery node 120 and the client delivery nodes 140, 142, and 144) by streaming a sequence of encoded audio and/or video frames as independent encoded audio and/or video frames and without grouping frames into chunks for delivery, as depicted at 160. In other words, the end-user clients (including end-user clients 130, 150, and 152) receive the audio/video streams without sending requests for a next chunk of streaming content (as would normally be done with a content delivery network). As a result, audio/video streaming is performed within the example environment 100 with low overhead and very low latency (e.g., no requests from the end-user clients for subsequent frames).

In addition, audio/video streaming that within the streaming architecture depicted in the example environment 100 is performed by directly streaming the encoded audio and/or video frames (e.g., directly streaming from the primary delivery node 120 to the client delivery node 140, to the client delivery node 144, and ultimately to the end user clients 152). The direct streaming is performed without any caching or buffering by the delivery nodes, as depicted at 160. For example, when client delivery node 140 receives encoded frames of audio and/or video content from the primary delivery node 140, client delivery node 140 sends the encoded frames to client delivery node 142 and client delivery node 144 (e.g., by making copies of the received encoded frames as needed) without any caching or buffering, and without waiting for requests for additional frames from client delivery node 142 and client delivery node 144. In this way, the audio/video streaming, once it has begun, is a one-way stream. As a result, audio-video streaming is performed within the example environment with low overhead and with very low latency.

In addition, the example environment 100 supports efficient forking of audio/video streams (e.g., with low overhead). For example, an audio video stream can be forked so that the audio/video stream can be delivered to additional end-user clients and/or additional delivery nodes. Forking is performed by sending stream metadata to the new end-user clients and/or delivery nodes. Once the end-user clients and/or delivery nodes have selected the stream (or streams) they want, streaming begins and continues without any additional requests from the new end-user clients and/or delivery nodes. In this way, forking can be performed efficiently to deliver the audio/video stream to many additional streaming clients. For example, if thousands of new streaming clients join, they can be efficiently added by sending stream metadata, receiving requests for selected audio/videos streams, and forking the audio/video streams (which are already being received by the delivery node) to send the audio/video streams to the new streaming clients.

In a typical streaming scenario, the primary delivery node 120 provides a variety of audio/video streams of different quality, all encoding the same audio and/or video content received from the media source 110. For example, the primary delivery node 120 could provide a high quality audio/video stream, a medium quality audio/video stream, and a low quality audio/video stream containing the same audio and/or video content that was received from the media source 110, just encoded and different qualities. Each end-user client and delivery node can select which audio/video streams to receive. For example, a given end-user client can receive stream metadata describing the available audio/video streams and select one to receive. A given client delivery node could receive all available audio/video streams (e.g., so that it can provide all options to downstream client delivery nodes and/or end-user clients) or only a subset of the available audio/video streams (e.g., the client delivery node may only receive low and medium quality streams if it is only currently serving end-user clients that have selected those quality streams).

The different quality audio/video streams that are provided within the example environment 100 are client-independent audio/video streams that are not specific to any given streaming client. For example, if a new end-user client wants to begin receiving a stream, it first receives stream metadata describing the available audio/video streams, each having its associated pre-defined quality. The end-user client selects the desired quality audio/video stream to receive and beings receiving the selected audio/video stream. The selected audio/video stream is not tailored to the specific streaming client, but the streaming client can select the desired quality audio/video stream (from those available) based on various criteria, such as available computing resources at the streaming client, current network bandwidth and conditions, etc.

The example environment 100 can deliver audio/video streams using a variety of transport layer network protocols. For example, delivery of audio/video streams can be performed using lossless transport protocols (e.g., transmission control protocol (TCP)) or a lossy transport protocol (e.g., user datagram protocol (UDP)).

Using the techniques described above with regard to the example environment 100, streaming of audio and/or video content can be performed to many end-user clients (e.g., 100,000 or more end-user clients) efficiently and with low latency (e.g., with less than one-second of latency). For example, a real-time media session (e.g., a real-time audio and/or video meeting) can be provided by the media source 110, travel through various primary delivery nodes (e.g., primary delivery node 120) and/or client delivery nodes (e.g., client delivery nodes 140, 142, and 144), and reach the end-user clients (e.g., end-user clients 130, 150, and 152) with low latency and low overhead. Therefore, using the techniques described herein, the streaming architecture can support virtually any number of end-user clients while still allowing the end-user clients to have meaningful interaction or engagement with the streaming media content if desired (e.g., if the streaming media content is part of a real-time meeting, then end-user clients could interact with the meeting participants in real-time).

The streaming clients can switch between various quality audio/video streams as needed. For example, a given end-user client can send a message to the delivery node to switch to a different quality audio/video stream. In response, the delivery node stops sending the old quality audio/video stream and starts sending the new quality audio/video stream. The streaming client can perform the switch based on previously received stream metadata or request (or receive) updated stream metadata (e.g., the available pre-defined quality audio-video streams may have changed).

The example environment 100 depicts a single primary delivery node 120. However, other implementations can include any number of primary delivery nodes, each receiving the streaming audio and/or video content from the media source 110 and/or from another primary delivery node. Further, each of the primary delivery nodes can stream to any number of clients and/or delivery nodes (e.g., primary delivery nodes or client delivery nodes).

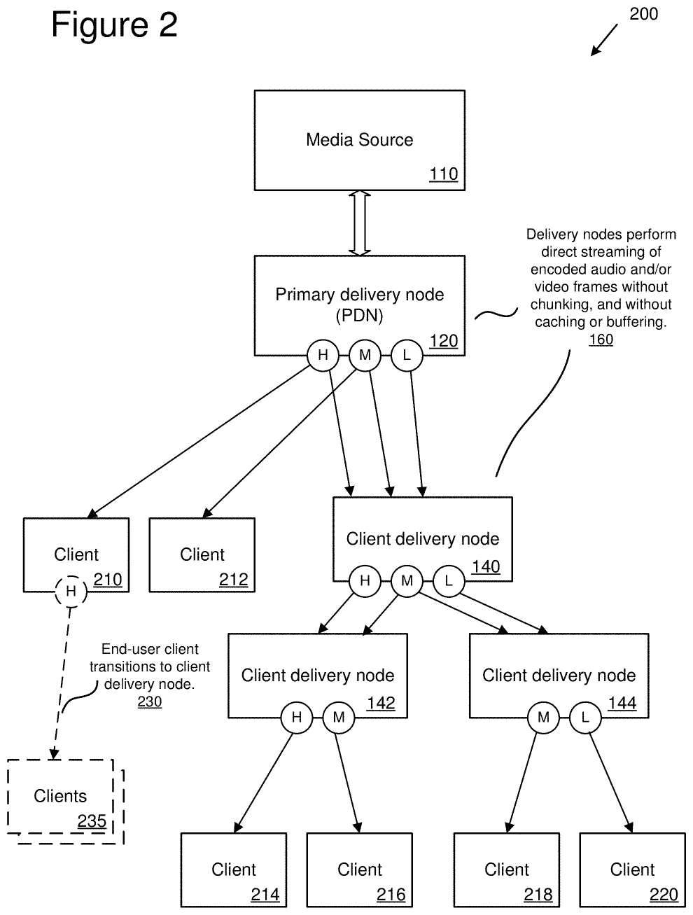

FIG. 2 is a diagram depicting an example environment 200 for low-latency real-time streaming of media content, including streaming of multiple pre-defined audio/video streams. The example environment 200 is similar to the example environment 100 depicted in FIG. 1, with additional description of how the multiple pre-defined audio/video streams operate.

As depicted in the example environment 200, the primary delivery node 120 has a set of pre-defined available audio/video streams. In this example, the set of pre-defined available audio/video streams include a high quality (H) audio/video stream, a medium quality (M) audio/video stream, and a low quality (L) audio/video stream. The set of pre-defined available audio/video streams can be generated by the primary delivery node 120. For example, the primary delivery node 120 can receive the streaming audio and/or video content from the media source 110 and generate the high, medium, and low quality representations of the streaming audio and/or video content by encoding using one or more audio and/or video codecs. The primary delivery node 120 could also receive the high, medium, and low quality streams as already encoded streams representing the streaming audio and/or video content (e.g., from the media source 110 or from another source, such as an intermediary media encoding and/or compositing service).

The primary delivery node 120 streams one or more of the pre-defined available audio/video streams to end-user clients and/or client delivery nodes. In some implementations, the primary delivery node 120 provides stream metadata to requesting end-user clients and client delivery nodes, which then request one or more of the pre-defined available audio/video streams to receive. For example, end-user client 210 has selected the high quality audio/video stream to receive, while end-user client 212 has selected the medium quality audio/video stream to receive. Client delivery node 140 has selected the entire set of pre-defined available audio/video streams (high, medium, and low quality) to receive, and therefore will be able to stream any of the audio/video streams in the set.

In this example, client delivery node 142 has requested the high and medium quality pre-defined audio/video streams, and is streaming the high quality audio/video stream to end-user client 214 and the medium quality audio/video stream to end-user client 216. Client delivery node 144 has requested the medium and low quality pre-defined audio/video streams, and is streaming the medium quality audio/video stream to end-user client 218 and the low quality audio/video stream to end-user client 220.

In some implementations, an end-user client can transition to become a client delivery node and stream audio/video streams to other end-user clients and/or client delivery nodes. In this example, end-user client 210 has transitioned into a client delivery node, as depicted at 230. After becoming a client delivery node, end-user client 210 can provide stream metadata to other end-user clients and/or client delivery nodes, receive requests for available pre-defined audio/video streams, and stream selected audio/video streams. In this example, end-user client 210 (now also operating as a client delivery node) is streaming the high quality audio/video stream to end-user clients 235.

In some implementations, the media source 110 represents a number of components (e.g., a number of cloud services, which could be running localized or distributed arrangement). For example, the media source 110 could comprise a media processor component that receives real-time audio and/or video content (e.g., from a real-time meeting), a media composition runtime component that receives the real-time audio and/or video content from the media processor and composites the content into one or more audio/video streams (e.g., including multiple pre-defined quality streams) that are provided to one or more primary delivery nodes, and a lookup service that facilitates discovery and communication between the primary delivery nodes and the other components.

### Streaming Protocol

In the technologies described herein, a new streaming protocol is provided for low-latency real-time streaming of media content. In some implementations, the new streaming protocol is a one-way streaming protocol that does not permit receiving requests.

The new streaming protocol includes a setup procedure. During the setup procedure, the streaming client sends a request (e.g., to a delivery node) for available audio/video streams. In some implementations, the request is sent as a hypertext transfer protocol (HTTP) request. In response, the streaming client receives stream metadata (also referred to as a track list) describing the pre-defined audio/video streams that are available. For example, a number of pre-defined quality audio/video streams may be available, such as a high quality stream, a medium quality stream, and a low quality stream.

The streaming client then selects one of the pre-defined audio/video streams to receive. In some implementations, the request for one of the pre-defined audio/video streams is sent (e.g., to a delivery node) as an HTTP request. In response, the streaming client receives one or more track setup objects. Each track setup object describes the properties of a corresponding track of the selected audio/video stream. An example track setup object describing an H.264 video track could comprise information such as: frame rate, sequence parameter set (SPS) and the picture parameter set (PPS) information, profile information, and/or other information that allows the streaming client to configure its decoder for receiving and decoding H.264 encoded video frames. An example track setup object describing an Opus audio track could comprise information such as: sample rate, sample duration, number of channels, and/or other information that allows the streaming client to configure its decoder for receiving and decoding Opus encoded audio data.

The new streaming protocol is then used to stream encoded audio and/or video frames to the streaming client. The new streaming protocol streams the encoded audio and/or video frames as independent encoded audio and/or video frames without grouping frames into chunks for streaming. In addition, the encoded audio and/or video frames streamed by the new streaming protocol are not seekable (i.e., the client cannot send a request for a specific frame or chunk, such as using a timestamp). In other words, the new protocol is a stream-based protocol that streams encoded audio and/or video frames in real time and without caching or buffering the frames. The client receives the audio/video stream and begins decoding in real-time (e.g., beginning with the next key frame).

In some implementations, the new streaming protocol is a one-way streaming protocol that does not permit receiving requests. In these implementations, requests that are received from downstream streaming clients are received using a different network protocol, such as HTTP. For example, a primary delivery node can receive HTTP requests from streaming clients for available audio/video streams and HTTP requests from streaming clients for selected audio/video streams to begin streaming. The primary delivery node can use the new streaming protocol when sending data to the steaming client (e.g., when sending stream metadata, when sending track setup objects, and when streaming encoded audio and/or video frames).

The new streaming protocol is defined at a higher layer than the transport layer. Therefore, the new streaming protocol can use a variety of transport layer network protocols for delivering the encoded audio and/or video frames. For example, the new streaming protocol can use a lossless transport protocol (e.g., TCP) or a lossy transport protocol (e.g., UDP).

### Methods for Low-Latency Real-Time Streaming of Media Content

In any of the examples herein, methods can be provided for low-latency real-time streaming of media content. The methods can be performed by delivery nodes (e.g., primary delivery nodes and/or client delivery nodes) or by streaming clients.

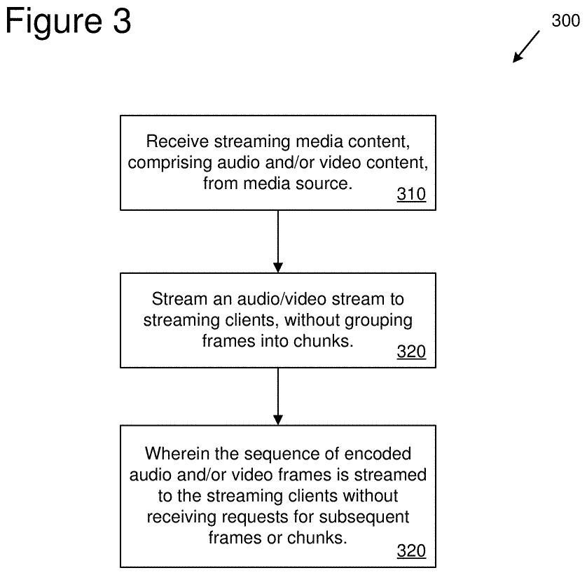

FIG. 3 is a is a flowchart of an example method 300 for low-latency real-time streaming of media content. For example, the example method 300 can be performed by a delivery node, such as primary delivery node 120 or client delivery node 140, 142, or 144.

At 310, streaming media content is received from a media source. The streaming media content comprises audio and/or video content.

At 320, an audio/video stream is streamed to one or more streaming clients. The audio/video stream is streamed as a sequence of encoded audio and/or video frames that are generated from the media content. The sequence of encoded audio and/or video frames is streamed as independent encoded audio and/or video frames without grouping the frames into chunks. In some implementations, the audio/video stream is streamed to the one or more streaming clients without caching or buffering the encoded audio and/or video frames.

At 330, the sequence of encoded audio and/or video frames is streamed to the one or more streaming clients as a one-way stream and without receiving requests form the one or more streaming clients for subsequent frames or chunks. In some implementations, the sequence of encoded audio and/or video frames is streamed using a streaming protocol that does not support sending requests to the delivery node of subsequent frames or chunks.

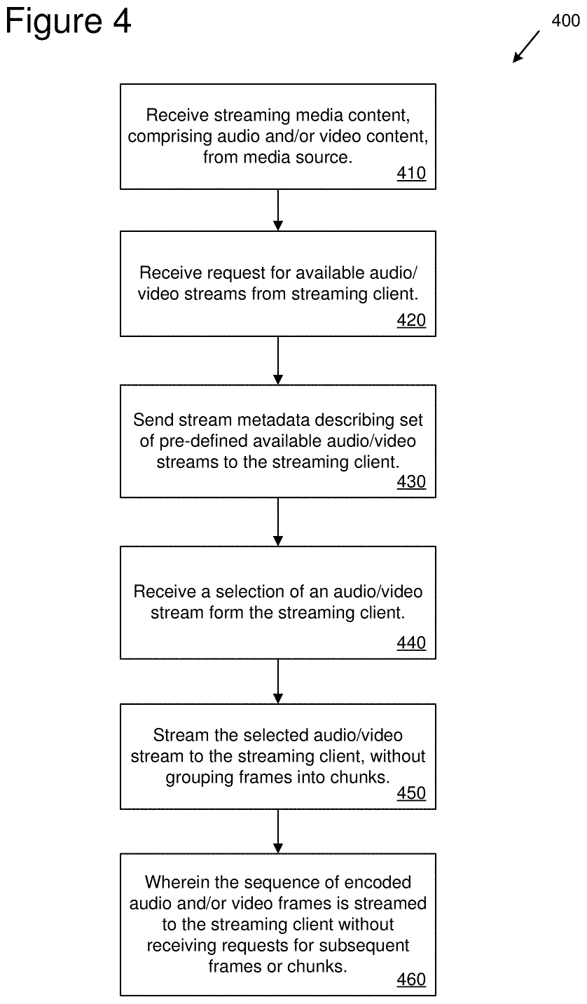

FIG. 4 is a is a flowchart of an example method 400 for low-latency real-time streaming of media content, including sending stream metadata. For example, the example method 400 can be performed by a delivery node, such as primary delivery node 120 or client delivery node 140, 142, or 144.

At 410, streaming media content is received from a media source. The streaming media content comprises audio and/or video content.

At 420, a request for available audio/video streams is received from a streaming client. For example, the request can comprise an indication (e.g., a unique identifier) of the streaming media content that the streaming client wants to receive. In some implementations, the request is received from the streaming client via an HTTP request.

At 430, in response to the request at 420, stream metadata is sent to the streaming client. The steam metadata describes a set of pre-defined available audio/video streams (having corresponding pre-defined qualities) for streaming the streaming media content. The set of pre-defined available audio/video streams are client-independent audio/video streams that are not specific to any given streaming client.

At 440, a selection of an audio/video stream (from the set of pre-defined available audio/video streams) is received from the streaming client. In some implementations, the request is received from the streaming client via an HTTP request.

At 450, in response to the selection at 440, the selected audio/video stream is steamed to the streaming client. The selected audio/video stream is streamed as a sequence of encoded audio and/or video frames that are independent encoded audio and/or video frames without grouping frames into chunks. In some implementations, the audio/video stream is streamed to the streaming client without caching or buffering the encoded audio and/or video frames

At 460, the sequence of encoded audio and/or video frames is streamed to streaming client as a one-way stream and without receiving requests form the streaming client for subsequent frames or chunks. In some implementations, the sequence of encoded audio and/or video frames is streamed using a streaming protocol that does not support sending requests to the delivery node of subsequent frames or chunks.

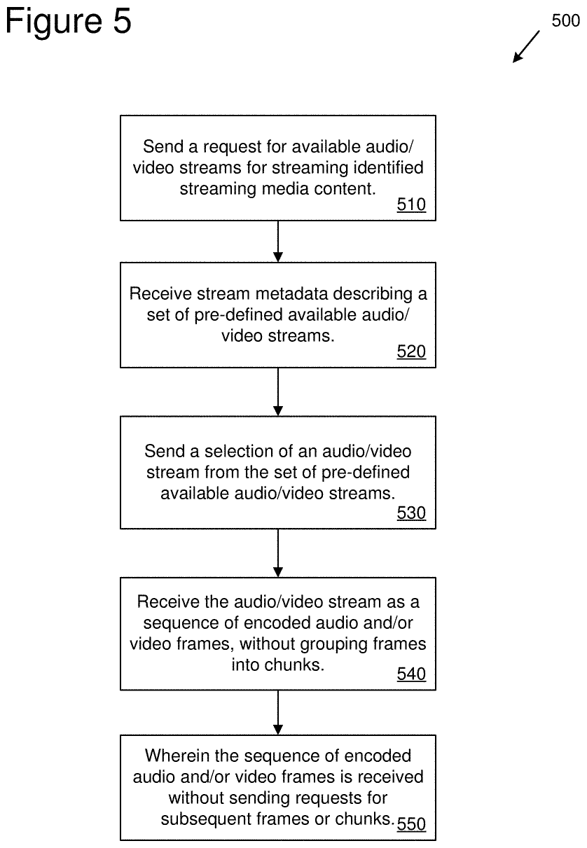

FIG. 5 is a is a flowchart of an example method 500 for low-latency real-time streaming of media content, including using stream metadata to select an audio/video stream. For example, the example method 500 can be performed by a streaming client, such as an end-user client or a client delivery node.

At 510, a request is sent (e.g., to a delivery node) for available audio/video streams for streaming identified streaming media content. For example, the request can identify (e.g., using a unique identifier) the streaming media content.

At 520, in response to the request at 510, steam metadata is received. The stream metadata describes a set of pre-defined available audio/video streams for streaming the streaming media content. The set of pre-defined plurality of audio/video streams are client-independent audio/video streams that are not specific to any given streaming client.

At 530, a selection of an audio/video stream from the set of pre-defined available audio/video streams is sent (e.g., to the delivery node). For example, the stream metadata can comprise indications (e.g., unique identifiers) of the pre-defined available audio/video streams, which can be used when selecting the audio/video stream.

At 540, the audio/video stream that was selected at 530 is received. The audio/video stream is received as a sequence of encoded audio and/or video frames that are independent encoded audio and/or video frames without grouping frames into chunks.

At 550, the sequence of encoded audio and/or video frames is received as a one-way stream and without sending any requests (e.g., to the delivery node) for subsequent frames or chunks. In some implementations, the sequence of encoded audio and/or video frames is received using a streaming protocol that does not support sending requests to the delivery node of subsequent frames or chunks.

### Computing Systems

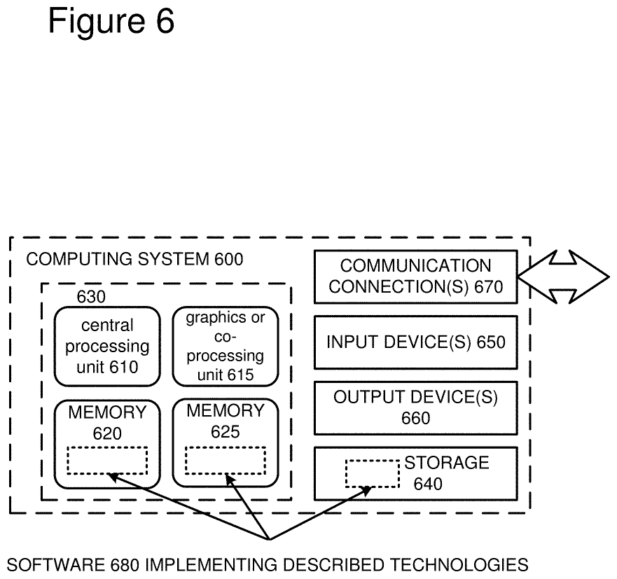

FIG. 6 depicts a generalized example of a suitable computing system 600 in which the described technologies may be implemented. The computing system 600 is not intended to suggest any limitation as to scope of use or functionality, as the technologies may be implemented in diverse general-purpose or special-purpose computing systems.

With reference to FIG. 6, the computing system 600 includes one or more processing units 610, 615 and memory 620, 625. In FIG. 6, this basic configuration 630 is included within a dashed line. The processing units 610, 615 execute computer-executable instructions. A processing unit can be a general-purpose central processing unit (CPU), processor in an application-specific integrated circuit (ASIC), or any other type of processor. A processing unit can also comprise multiple processors. In a multi-processing system, multiple processing units execute computer-executable instructions to increase processing power. For example, FIG. 6 shows a central processing unit 610 as well as a graphics processing unit or co-processing unit 615. The tangible memory 620, 625 may be volatile memory (e.g., registers, cache, RAM), non-volatile memory (e.g., ROM, EEPROM, flash memory, etc.), or some combination of the two, accessible by the processing unit(s). The memory 620, 625 stores software 680 implementing one or more technologies described herein, in the form of computer-executable instructions suitable for execution by the processing unit(s).

A computing system may have additional features. For example, the computing system 600 includes storage 640, one or more input devices 650, one or more output devices 660, and one or more communication connections 670. An interconnection mechanism (not shown) such as a bus, controller, or network interconnects the components of the computing system 600. Typically, operating system software (not shown) provides an operating environment for other software executing in the computing system 600, and coordinates activities of the components of the computing system 600.

The tangible storage 640 may be removable or non-removable, and includes magnetic disks, magnetic tapes or cassettes, CD-ROMs, DVDs, or any other medium which can be used to store information and which can be accessed within the computing system 600. The storage 640 stores instructions for the software 680 implementing one or more technologies described herein.

The input device(s) 650 may be a touch input device such as a keyboard, mouse, pen, or trackball, a voice input device, a scanning device, or another device that provides input to the computing system 600. For video encoding, the input device(s) 650 may be a camera, video card, TV tuner card, or similar device that accepts video input in analog or digital form, or a CD-ROM or CD-RW that reads video samples into the computing system 600. The output device(s) 660 may be a display, printer, speaker, CD-writer, or another device that provides output from the computing system 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The technologies can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Cloud-Supported Environment

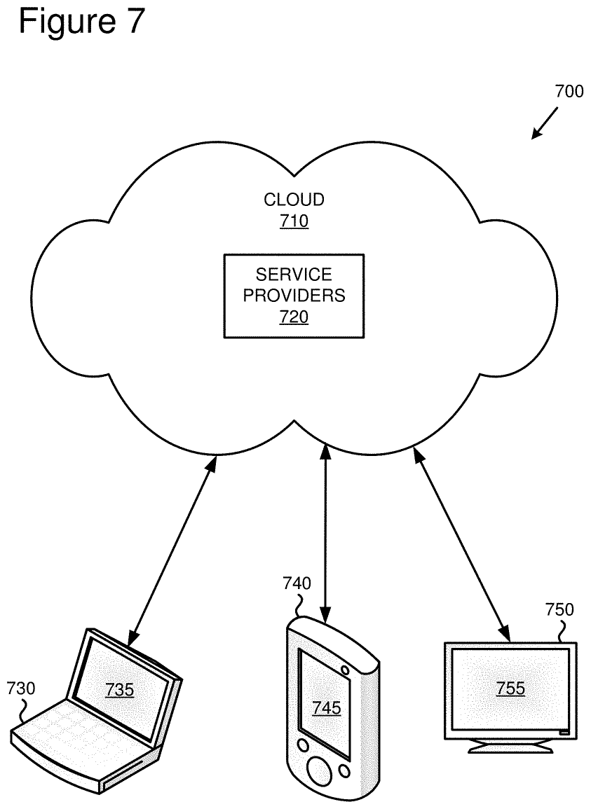

FIG. 7 illustrates a generalized example of a suitable cloud-supported environment 700 in which described embodiments, techniques, and technologies may be implemented. In the example environment 700, various types of services (e.g., computing services) are provided by a cloud 710. For example, the cloud 710 can comprise a collection of computing devices, which may be located centrally or distributed, that provide cloud-based services to various types of users and devices connected via a network such as the Internet. The implementation environment 700 can be used in different ways to accomplish computing tasks. For example, some tasks (e.g., processing user input and presenting a user interface) can be performed on local computing devices (e.g., connected devices 730, 740, 750) while other tasks (e.g., storage of data to be used in subsequent processing) can be performed in the cloud 710.

In example environment 700, the cloud 710 provides services for connected devices 730, 740, 750 with a variety of screen capabilities. Connected device 730 represents a device with a computer screen 735 (e.g., a mid-size screen). For example, connected device 730 could be a personal computer such as desktop computer, laptop, notebook, netbook, or the like. Connected device 740 represents a device with a mobile device screen 745 (e.g., a small size screen). For example, connected device 740 could be a mobile phone, smart phone, personal digital assistant, tablet computer, and the like. Connected device 750 represents a device with a large screen 755. For example, connected device 750 could be a television screen (e.g., a smart television) or another device connected to a television (e.g., a set-top box or gaming console) or the like. One or more of the connected devices 730, 740, 750 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 700. For example, the cloud 710 can provide services for one or more computers (e.g., server computers) without displays.

Services can be provided by the cloud 710 through service providers 720, or through other providers of online services (not depicted). For example, cloud services can be customized to the screen size, display capability, and/or touchscreen capability of a particular connected device (e.g., connected devices 730, 740, 750).

In example environment 700, the cloud 710 provides the technologies and solutions described herein to the various connected devices 730, 740, 750 using, at least in part, the service providers 720. For example, the service providers 720 can provide a centralized solution for various cloud-based services. The service providers 720 can manage service subscriptions for users and/or devices (e.g., for the connected devices 730, 740, 750 and/or their respective users).

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (i.e., any available computing device, including smart phones or other mobile devices that include computing hardware). Computer-readable storage media are tangible media that can be accessed within a computing environment (one or more optical media discs such as DVD or CD, volatile memory (such as DRAM or SRAM), or nonvolatile memory (such as flash memory or hard drives)). By way of example and with reference to FIG. 6, computer-readable storage media include memory 620 and 625, and storage 640. The term computer-readable storage media does not include signals and carrier waves. In addition, the term computer-readable storage media does not include communication connections, such as 670.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology.

What is claimed is:

1. A computing device comprising:
a processor;
a network interface; and
memory;
the computing device configured to perform operations for low-latency real-time streaming of media content, the operations comprising:
receiving, from a media source, streaming media content, wherein the streaming media content comprises audio and/or video content; and
streaming an audio/video stream with a sequence of encoded audio and/or video frames, generated from the streaming media content, to one or more streaming clients, wherein the sequence of encoded audio and/or video frames is streamed as independent encoded audio and/or video frames without grouping frames into chunks for the streaming;
wherein the sequence of encoded audio and/or video frames is streamed to the one or more streaming clients as a one-way stream and without receiving any requests from the one or more streaming clients for subsequent frames or chunks.

2. The computing device of claim 1, wherein, the one or more streaming clients comprise one or more end-user clients and one or more client delivery nodes.

3. The computing device of claim 1, the operations further comprising:
generating a pre-defined plurality of audio/video streams, wherein each of the pre-defined plurality of audio/video streams is encoded with a different pre-defined quality;
wherein the audio/video stream that is streamed to the one or more streaming clients is one of the pre-defined plurality of audio/video streams; and
wherein the pre-defined plurality of audio/video streams are client-independent audio/video streams that are not specific to any given streaming client.

4. The computing device of claim 3, the operations further comprising:
sending, to the one or more streaming clients, stream metadata comprising information describing the pre-defined plurality of audio/video streams; and
receiving, from the one or more streaming clients, requests to receive the audio/video streams from the pre-defined plurality of audio-video streams.

5. The computing device of claim 1, the operations further comprising:
receiving, from the one or more streaming clients, a request for available audio/video streams, wherein the available audio/video streams are a set of pre-defined available audio/video streams;
sending, to the one or more streaming clients, stream metadata describing the available audio/video streams;
receiving, from the one or more streaming clients, a request for the audio/video stream from the available audio/video streams; and
sending, to the one or more streaming clients, one or more track setup objects describing properties of the sequence of encoded audio and/or video frames for the audio/video stream, wherein the properties are usable by the one or more streaming clients when receiving and decoding the sequence of encoded audio and/or video frames.

6. The computing device of claim 1, the operations further comprising:
forking the audio/video stream by:
based on stream metadata sent to one or more additional streaming clients, receiving requests from the one or more additional streaming clients to begin streaming the audio/video stream; and
responsive to receiving the requests form the one or more additional streaming clients to begin streaming the audio/video stream, streaming the audio/video stream to the one or more additional streaming clients, wherein the sequence of encoded audio and/or video frames is streamed as independent encoded audio and/or video frames without grouping frames into chunks for the streaming;
wherein the sequence of encoded audio and/or video frames is streamed to the one or more additional streaming clients as a one-way stream and without receiving any requests from the one or more additional streaming clients for subsequent frames or chunks;
wherein the forking is performed with low overhead based at least in part on the stream metadata and the request to being streaming.

7. The computing device of claim 1, wherein the streaming is performed without caching or buffering the sequence of encoded audio and/or video frames.

8. The computing device of claim 1, the operations further comprising:
receiving, from one of the one or more streaming clients, a request to switch to a different audio/video stream from a set of pre-defined audio/video streams generated from the streaming media content; and
responsive to the request to switch, streaming the different audio/video stream with a different sequence of encoded audio and/or video frames, to the streaming client, wherein the different sequence of encoded audio and/or video frames is not grouped into chunks;
wherein the different sequence of encoded audio and/or video frames is streamed to the streaming client as a one-way stream and without receiving any requests from the streaming client for subsequent frames or chunks.

9. The computing device of claim 1, wherein the computing device operates as a primary delivery node.

10. A method, implemented by a computing device, for low-latency real-time streaming of media content, the method comprising:
receiving, from a media source, streaming media content, wherein the streaming media content comprises audio and/or video content;
receiving, from a streaming client, a request for available audio/video streams for streaming the streaming media content;
sending, to the streaming client, stream metadata describing a set of pre-defined available audio/video streams for streaming the streaming media content, wherein the set of pre-defined available of audio/video streams are client-independent audio/video streams that are not specific to any given streaming client;
receiving, from the streaming client, a selection of an audio/video stream from the set of pre-defined available audio/video streams; and
streaming the selected audio/video stream to the streaming client, wherein the selected audio/video stream is streamed as a sequence of encoded audio and/or video frames that are independent encoded audio and/or video frames without grouping frames into chunks for the streaming;
wherein the sequence of encoded audio and/or video frames is streamed to the streaming client as a one-way stream and without receiving any requests from the streaming client for subsequent frames or chunks.

11. The method of claim 10, further comprising:
receiving, from one or more additional streaming clients, a request for available audio/video streams for streaming the streaming media content;
sending, to the one or more additional streaming clients, the stream metadata;
receiving, from the one or more additional streaming clients, a selection of the audio/video stream from the set of pre-defined available audio/video streams; and
forking the audio/video stream to begin streaming the audio/video stream to the one or more additional streaming clients.

12. The method of claim 10, further comprising:
receiving, from the streaming client, a request to switch to a different audio/video stream from the set of pre-defined available audio/video streams for streaming the streaming media content; and
responsive to the request to switch, streaming the different audio/video stream with a different sequence of encoded audio and/or video frames, to the streaming client, wherein the different sequence of encoded audio and/or video frames is not grouped into chunks;
wherein the different sequence of encoded audio and/or video frames is streamed to the streaming client as a one-way stream and without receiving any requests from the streaming client for subsequent frames or chunks.

13. The method of claim 10, further comprising:
streaming the selected audio/video stream to a plurality of additional streaming clients, the plurality of additional streaming clients comprising one or more end-user clients, one or more client delivery nodes, and/or one or more primary delivery nodes.

14. The method of claim 10, wherein the computing device operates as a primary delivery node or a client delivery node.

15. A method, implemented by a computing device, for low-latency real-time streaming of media content, the method comprising:
sending, to a delivery node, a request for available audio/video streams for streaming identified streaming media content;
receiving, from the delivery node, stream metadata describing a set of pre-defined available audio/video streams for streaming the streaming media content, wherein the set of pre-defined available audio/video streams are client-independent audio/video streams that are not specific to any given streaming client;
sending, to the delivery node, a selection of an audio/video stream from the set of pre-defined available audio/video streams; and
receiving, from the delivery node, the audio/video stream, wherein the audio/video stream is received as a sequence of encoded audio and/or video frames that are independent encoded audio and/or video frames and without grouping frames into chunks;
wherein the sequence of encoded audio and/or video frames is received as a one-way stream and without sending any requests to the delivery node for subsequent frames or chunks.

16. The method of claim 15 further comprising:
sending, to the delivery node, a request to switch to a different audio/video stream from the set of pre-defined available audio/video streams for streaming the streaming media content; and
responsive to the request to switch, receiving, from the delivery node, the different audio/video stream that is streamed as a different sequence of encoded audio and/or video frames, wherein the different sequence of encoded audio and/or video frames is not grouped into chunks;
wherein the different sequence of encoded audio and/or video frames is received as a one-way stream and without sending any requests from the delivery node for subsequent frames or chunks.

17. The method of claim 15, the client computing device initially operates as an end-user client when receiving the audio/video stream, the method further comprising:
receiving, from a streaming client, a request to stream the audio/video stream; and
beginning operation as a client delivery node, comprising:
streaming the audio/video stream to the streaming client, wherein the audio/video stream is streamed as the sequence of encoded audio and/or video frames that are independent encoded audio and/or video frames without grouping frames into chunks for the streaming;
wherein the sequence of encoded audio and/or video frames is streamed to the streaming client as a one-way stream and without receiving any requests from the streaming client for subsequent frames or chunks.

18. The method of claim 15 wherein the request for available audio/video streams is sent to the delivery node as a first HTTP request, and wherein the selection of the audio/video stream is sent to the delivery node as a second HTTP request.

19. The method of claim 15 wherein the audio/video stream is received from the delivery node using a one-way streaming protocol that does not support sending requests to the delivery node.

20. The method of claim 15 further comprising:
responsive to sending the request for the audio/video stream, receiving, from the delivery node, one or more track setup objects describing properties of the sequence of encoded audio and/or video frames for the audio/video stream, wherein the properties are usable when receiving and decoding the sequence of encoded audio and/or video frames.
